(19) United States
(12) Patent Application Publication
(10) Pub. No.: US 2025/0052298 A1
(43) Pub. Date: Feb. 13, 2025

(54) Electromagnetic Restrainer of Relative Motion Among Chain Links

(71) Applicant: Abdullah Othman Fallatah, Jeddah (SA)

(72) Inventor: Abdullah Othman Fallatah, Jeddah (SA)

(21) Appl. No.: 18/799,151

(22) Filed: Aug. 9, 2024

Related U.S. Application Data
(60) Provisional application No. 63/518,559, filed on Aug. 10, 2023.

(51) Int. Cl. F16G 13/18; F16G 15/00; H01F 7/08

(52) U.S. Cl. CPC F16G 13/18; F16G 15/00; H01F 7/08

(57) ABSTRACT

A chain link having an electromagnetic force generation system between two chain links which including an attachable electromagnetic unit installed on multiple links. The chain having have a power source in order to generate an electrical current. As the electrical current passes, it creates repulsive and/or attractive force between chain links in order for them to be aligned with each other, achieving a rigid status.

### CROSS-REFERENCE TO RELATED APPLICATIONS

This application claims priority to U.S. Provisional Application 63/518,559, filed on Aug. 10, 2023, which is hereby incorporated by reference in its entirety.

### FIELD OF THE DISCLOSURE

The present disclosure is related to a link chain which is able to restrain the relative motion between two chain links using electromagnetic repulsive or attractive force.

### BACKGROUND

Indispensable in practical applications, metallic chains of all types have been important tools to humanity since ancient times. People use chains in various fields such as: jewelry, lifting, fixation, power transmission and weapons. They are available in different sizes and shapes such as: oval, round and roller.

The design of the chain allows it to be jointly flexible as it is made from connected links which can move relatively freely from each other. This design is also advantageous in storing chains as they do not require a significant storage area when compared to alternative tools.

Fixation applications require a flexible tool that can be formed yet very resilient to withstand different kinds of load. Chains that are used to fix parts—also known as lashing chains—are usually subjected to fatigue load which consists repeated loads occur in cycles. The chain must endure fatigue load during shipping and securing heavy parts.

In lifting, the chain is subjected to axial load. It happens naturally due to the resistance to gravitational force and it is translated to weight. For that reason, sellers of chains have to demonstrate the weight capacity for each one of them.

However, there is a significant problem when lifting by conventional chains. The only thing that keeps the lifted part stable is its weight. So, whenever the part is relatively light in weight, wind current or other uncontrollable factors can make it very hard to execute handling work due to swinging. Furthermore, where a place with no gravity whatsoever like outer space, the chain will be almost useless for lifting.

Therefore, there is a need for a novel chain that is capable of fixing the lifted part in the required position. The modified chain should not be dependent on gravity for it to be functional for fixation application. A further need in the modified chain is to be flexible in the normal condition and becomes rigid when needed. That will allow the chain user to lift the required part and then suspend it in a certain position. This feature is highly required in position-sensitive application like welding and fitting.

### DISCLOSURE SUMMARY

The disclosure is related to the conventional chain link. It suggests a solution to the problem of chain instability during little to no gravity presence. The solution comprises two connected links with a practical modification. Each link has attachable electromagnetic unit which activated by an electrical current when rigid status for the chain is needed. The current generates attractive or repulsive forces between each two links which ultimately leads the chain to be firmly straight.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows an example of a perspective side view of an electromagnetic restrainer of relative motion among chain links.

FIG. 2 shows an example of a front view of an electromagnetic restrainer of relative motion among chain links according to various embodiments of the present disclosure.

FIG. 3 shows a top view (A) and a cross-sectional top view (B) of an electromagnetic restrainer of relative motion among chain links according to various embodiments of the present disclosure.

FIG. 4 shows a loose chain with no electrical current passing through cables with multiple electromagnetic restrainers of relative motion among chain links according to various embodiments of the present disclosure.

FIG. 5 illustrates a chain with electrical current passing through cables with electromagnetic restrainers of relative motion among chain links where each electromagnetic pad functioning and cause attractive and/or repulsive force according to various embodiments of the present disclosure.

### DETAILED DESCRIPTION

The terminology used herein is for the purpose of describing particular embodiments only and is not intended to be limiting of the disclosure. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence of additional one or more other features, steps, operations, elements, components, and/or groups thereof.

Unless otherwise defined, all terms (including technical and scientific terms) used herein have the same meaning as commonly understood by one having ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the disclosure, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification should be read with the understanding that such combinations are entirely within the scope of the disclosure.

Electromagnetic restrainer of relative motion among chain links is discussed herein. In the following description, for purposes of explanation, numerous specific details are set forth in order to provide a thorough understanding of the present disclosure.

The present disclosure is to be considered as an exemplification of the disclosure, and is not intended to limit the disclosure to the specific embodiments illustrated by the figures or description below.

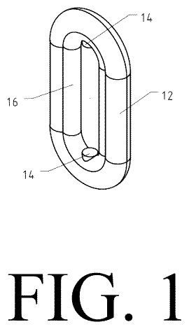

The present disclosure will now be described by referencing the appended figures representing preferred embodiments. FIG. 1 shows an example of a perspective side view of an electromagnetic restrainer of relative motion among chain links. In preferred embodiments, there is a singular conventional link 12 with an electromagnetic unit attached to it. The electromagnetic unit contains upper and lower electromagnetic pads 14 and cable trunking 16 which house electrical cables 16a. Electrical cables 16a are not visible in FIG. 1 as they are buried inside cable trunking 16.

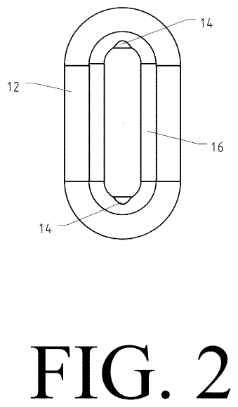

Referring to FIG. 2 depicts an example of a front view of an electromagnetic restrainer of relative motion among chain links according to various embodiments of the present disclosure. The attachable electromagnetic unit can be observed from another angle. Upper and lower electromagnetic pads 14 are connected to cable trunking 16 which house electrical cables 16a. Electrical cables 16a are not visible in FIG. 2 as they are buried inside cable trunking 16.

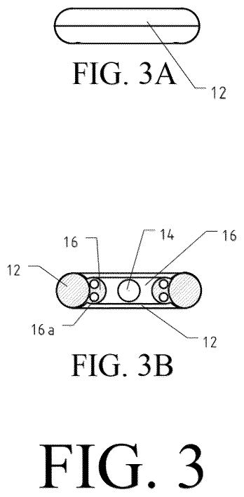

As shown in FIG. 3 a bottom view (A) and a cross-sectional bottom view (B) of a front view of an electromagnetic restrainer of relative motion among chain links according to various embodiments of the present disclosure. Electromagnetic pads 14 and cable trunking 16 are not visible in FIG. 3A as they are smaller than link width. Electrical cables 16a are not visible in FIG. 3A as they are buried inside cable trunking 16. However, in the cross-sectional bottom view FIG. 3B electromagnetic pads 14, cable trunking 16 and electrical cables 16a are visible. The purpose of the electrical cables 16a is to transmit current to electromagnetic pads 14 thus activate repulsive and/or attractive force among links when a rigid status of the chain is needed.

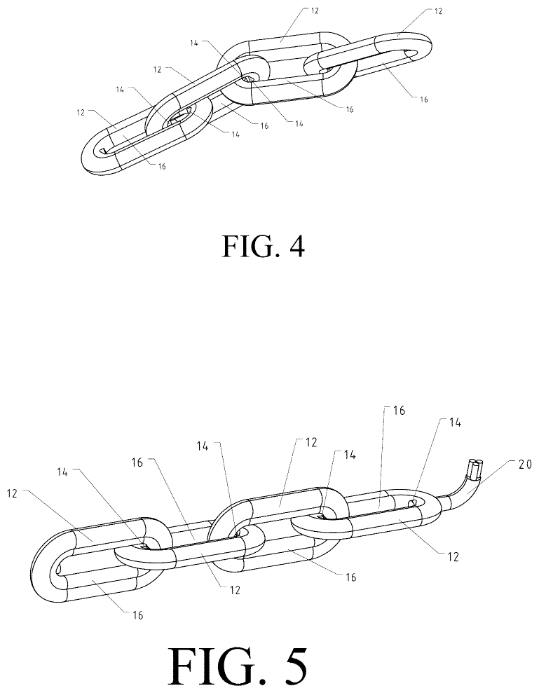

FIG. 4 illustrates a loose chain with no electrical current passing through cables with multiple electromagnetic restrainers of relative motion among chain links according to various embodiments of the present disclosure. When the chain is not utilized or in storage status, links are able to freely move in all directions. Regardless of its fixation purpose, the preferred embodiments of electromagnetic pads 14 allow this movement freedom to occur when a rigid status is not needed. The link with electromagnetic pads 14 in FIG. 2 does not have an effect over the other link as long as there is no current passing through to electromagnetic pads 14. This feature is highly required as the main advantage of chains over other alternatives is the ability to store them in a relatively smaller area due to their joints flexibility. Also, some applications require the chain to be loose either permanently or temporarily.

FIG. 5 illustrates a chain with electrical current passing through cables 16a with multiple electromagnetic restrainers of relative motion among chain links where each electromagnetic pad 14 functioning and cause attractive and/or repulsive force according to various embodiments of the present disclosure. When a rigid status is needed for the chain, first, the operator will initiate a power source connected to electrical cables 16a of the first link from the power source 20. The power source can is considered to be a high-voltage cable from a network or a generator. When this power source 20 is on, an electrical current will pass through electrical cables 16a and reach electromagnetic pads 14 initiating electromagnetic attractive and/or repulsive forces among the first link and the link next to it. The electromagnetic forces will cause the two links to align in line with each other. As the current travels along the chain, the effect of electromagnetic forces takes a place from one link to another down to the last link in the chain and eventually makes the entire chain rigid as a result.

Electromagnetic pads 14 and cable trunking 16 designs are not limited to embodiments shown in figures and explained herein. Electromagnetic pads 14 can be cylindrical in shape or rectangular and can be positioned on the sides of the link or on the top and the bottom. Cable trunking 16 can be positioned on the external edges rather than internal edges as shown in FIG. 2. Any embodiments of electromagnetic pads 14 discussed in the present disclosure can be manufactured using casting or machining. Any embodiments of cable trunking 16 discussed in the present disclosure can be manufactured using casting or forging. Any embodiments discussed in the present disclosure can be installed to the link using welding or chemical adhesive material.

The methods and systems of the present disclosure, as described above and shown in the drawings provide for a chain link that is better able to accommodate heavy loads and stresses. While the apparatus and methods of the subject disclosure have been showing and described with reference to embodiments, those skilled in the art will readily appreciate that changes and/or modifications may be made thereto without departing from the spirit and score of the subject disclosure.

What is claimed is:

1. A chain link comprising:
a plurality of links attached to each other wherein an electromagnetic force from a first of the plurality of links causes a repulsion or an attraction to at least a second one of the plurality of links to restrain motion between at least the first of the plurality of links and at least the second one of the plurality of links.

2. The chain link of claim 1, wherein the electromagnetic force is a repulsion.

3. The chain link of claim 1, wherein the electromagnetic force is an attraction.

4. A chain link comprising:
a plurality of links attached to each other, wherein at least two of the links include an electromagnetic pad configured to create an electromagnetic force to an adjacent link, and wherein the at least two of the links further include a trunking and an electric cable.

5. The chain link of claim 4, wherein each link includes two electromagnetic pads.

6. The chain link of claim 5, wherein the two electromagnetic pads are at opposite ends of each respective link.

7. The chain link of claim 4, wherein the trunking is positioned on an internal edge of each link.

8. The chain link of claim 4, wherein the trunking is positioned on an external edge of each link.

9. The chain link of claim 4, wherein the electric cable is located within the trunking.

10. The chain link of claim 4, further comprising a power source for providing a current.

11. The chain link of claim 10, wherein the power source is a high-voltage cable from a network or a generator.

12. The chain link of claim 11, wherein the power source is integrated into at least one link of the chain link.

13. A method comprising:
providing power via a power source to a first link of a chain link;
activating an electromagnetic pad of the first link by a current;
activating an electromagnetic pad of a second link;
producing an electromagnetic force between the activated electromagnetic pads; and
straightening the chain link by the electromagnetic force.

14. The method of claim 13, wherein the power source is a high-voltage cable from a network or a generator.

15. The method of claim 13, wherein the power source is integrated into at least one link of the chain link.

16. The method of claim 13, wherein each link includes two electromagnetic pads.

17. The method of claim 16, wherein the two electromagnetic pads are at opposite ends of each respective link.

18. The method of claim 13, wherein the chain link becomes completely straight.

19. The method of claim 13, wherein the chain link becomes rigid.

20. The method of claim 19, wherein the chain link loses rigidity when the power source is disconnected.
